(19) United States
(12) Patent Application Publication
(10) Pub. No.: US 2016/0299581 A1
(43) Pub. Date: Oct. 13, 2016

(54) NAVIGATION BY CHANGING SCREEN ORIENTATION

(71) Applicant: Jari Kristensen, Kirkland, WA (US)

(72) Inventor: Jari Kristensen, Kirkland, WA (US)

(21) Appl. No.: 15/095,866

(22) Filed: Apr. 11, 2016

Related U.S. Application Data
(60) Provisional application No. 62/146,260, filed on Apr. 11, 2015.

(51) Int. Cl. G06F 3/0346; G09G 5/38; G06F 3/0488; G06F 3/0485; G06F 3/0482; G06F 3/0484

(52) U.S. Cl. CPC G06F 3/0346; G06F 3/0482; G06F 3/04842; G06F 3/04883; G06F 3/0485; G09G 5/38; G06F 3/04845; G09G 2340/0471; G09G 2340/0478

(57) ABSTRACT

An orientation input system uses the change between portrait and landscape mode and vice versa as a powerful input control for navigation on a personal electronic device. Portrait mode provides a tall screen that is good for diving in depth into a content item. Landscape mode provides a wide screen that is good for comparing multiple content items side by side and selecting another item. The system uses the device's orientation not simply to resize content, but as an input to switch the user meaningfully between these two activities. This reduces the user's input and makes operation of the small device easier. Thus, the system provides a new way for a user to provide input and navigate content on a portable electronic device that is convenient for the user and helps the user achieve the user's goals for using the device more efficiently.

### CROSS-REFERENCE TO RELATED APPLICATIONS

The present application claims the benefit of U.S. Provisional Patent Application No. 62/146,260 (Attorney Docket No. FSP1067PROV) entitled “LANDSCAPE MODE MACHINE SEARCH INTERFACE,” and filed on Apr. 11, 2015, which is hereby incorporated by reference.

### BACKGROUND

Every year portable electronic devices make up a larger and larger percentage of the computing time of people. Devices such as smartphones, tablets, ultra-portable laptops, smart watches, and the like are carried by many people wherever they go. Unlike a traditional phone or watch, these devices are now used to access the Internet, run custom applications, and manage/consume large amounts of data. Everything from web browsing to sharing the important moments of a person's life is now often performed on such devices. Devices like these have various user interface controls for controlling navigation, such as on-screen buttons, hardware buttons, microphones for speech recognition, and so forth.

Typically, portable electronic devices have a rectangular screen that is longer along one dimension than another dimension. This leads to an ability for a user to use such a device with the screen oriented to have more height, called portrait mode, or to have more width, called landscape mode. In home theater and other areas, this is often referred to as aspect ratio, such as the common high definition (HD) aspect ratio of 16:9, which indicates that the width is 16/9 larger than the height. Most devices simply reformat the content to fit the current dimensions when a user switches from portrait to landscape mode. For example, in later versions of iOS, the Apple iPhone allows the home screen to be displayed in portrait or landscape mode, and simply rotates the icons and lays them out with appropriate spacing when switching between the two. Similarly, the Apple iPad does the same. Thus, portrait or landscape simply becomes a user preference for whether the content they are currently viewing benefits more from a wider screen or a taller screen, and the user can reorient the device to suit the content the user is currently using.

A persistent challenge with portable electronic devices is doing increasingly more complex tasks on relatively small screens compared to the computing devices of a few years ago. No longer are the robust control schemes of a keyboard and mouse routinely available on these devices. If a keyboard is available, it is often a software keyboard displayed on screen that takes away other screen space. User interface controls are typically in the form of a limited number of displayed buttons that a user can tap to perform various functions. To solve this problem, device makers have turned to alternative input controls, such as speech recognition, shaking the device, and other actions to give the user more robust ways to provide input to the device and interact with the growing amount of data that users consume through these devices.

### BRIEF DESCRIPTION OF THE DRAWINGS

FIG. 1 is a block diagram that illustrates components of the orientation input system, in one embodiment.

FIG. 2 is a flow diagram that illustrates processing of the orientation input system to navigate content using a transition from portrait to landscape mode, in one embodiment.

FIG. 3 is a flow diagram that illustrates processing of the orientation input system to navigate content using a transition from landscape to portrait mode, in one embodiment.

### DETAILED DESCRIPTION

An orientation input system is described herein that uses the change between portrait and landscape mode and vice versa as a powerful input control for navigation on a personal electronic device. Portrait mode provides a tall screen that is good for diving in depth into a content item, such as reading a long email, Facebook post, or web page. Landscape mode provides a wide screen that is good for comparing multiple content items side by side, such as when searching or filtering content to find a content item to view in more depth. The orientation input system uses the device's orientation not simply to resize content as in traditional systems, but as an input to switch the user meaningfully between these two activities. For example, imagine that a user is viewing a Facebook post in portrait mode and wants to search for other posts by that author. Today, that user would find a search button and navigate a user interface displayed in portrait mode for selecting the search criteria. The user might type the author's name in a search box and press a search button, and then be presented with a vertical list of search results.

Note that there is no connection between what the user was doing, viewing the Facebook post, and the user's next activity, searching for posts, the application has not used any context from the first activity to reduce the user's input for the second activity. In the orientation input system, every activity has context that is used to reduce the user's input when switching between orientations to do another activity. In the present example, when the user is viewing a Facebook post in portrait mode, the system is storing the current context as that Facebook post. When the user rotates the device to landscape mode, the system changes to a new activity, such as search, and uses that context to inform the activity, such as searching automatically for other posts by that author, without asking the user to type in any keywords. In addition, because the width of the screen provides room for several columns, the search results can include several categories of results, such as one column of posts by that author, another column of posts the recipient has made to that author's page, and another column of comments the recipient has made on that author's posts. This reduces the user's input and makes operation of the small device easier. Orientation would not have been used as a navigation control on older devices, because it would have been too cumbersome to pick up a desktop computer's monitor and turn it over when robust controls like a keyboard and mouse were available. However, for portable electronic devices, their small size makes changing orientation very easy, and using orientation for navigation is a powerful input mechanism that overcomes some of the smaller form factor's input limitations.

The user can continue in this manner going back and forth between portrait and landscape made to execute a very powerful workflow with very little typed input. For example, the user may start by viewing one social media post of an author in portrait mode, rotate to landscape to search for other posts, select a new post that the user finds in the search by tapping on it, then rotate to portrait mode to view that post in more depth. The user can then begin the process again, rotating again to landscape mode to search for something new and back to portrait when something new is found that the user wants to view in depth. In some cases, rotation to landscape mode establishes a primary key that is used for a search, and the user can tap on the screen to bring up a secondary key to further filter the search items. For example, the primary key may be the author that shared the current post, and a secondary key may be the type of thing shared, such as files, web pages, QR code scans, and so forth. The change of orientation becomes a very meaningful input from the user and a very powerful tool for efficient navigation of a large body of content. Thus, the orientation input system provides a new way for a user to provide input and navigate content on a portable electronic device that is convenient for the user and helps the user achieve the user's goals for using the device more efficiently.

One example content domain where the orientation input system has been beneficially applied is that described in U.S. patent application Ser. No. 14/158,473, entitled “ATTACHING SUPPLEMENTAL INFORMATION TO OBJECTS AND CONTENT USING MARKERS,” and filed on Jan. 17, 2014, which is incorporated herein by reference. That application describes a system in which a person can find content anywhere on the Internet, whether it be an email, Facebook post, web page, or any other content, and can share that content with other users through a new type of content post called a blitz. A blitz has a person who shared it, an audience that it is shared to, a subject item of content, and often other dimensions such as a location it was shared from, a retailer to which the blitz pertains, and so forth. Blitzes point users more quickly to the subset of the vast information on the Internet that a person's friends or other connections find most interesting. Friends may share thousands of pieces of content through blitzes and one challenge becomes navigating between these many pieces of content. Retailers may also provide promotions and other content through blitzes. The following examples show how the orientation input system is applied to the content domain of blitzes to provide a powerful navigation mechanism.

The first example is that of personal sharing of blitzes between friends. A user is looking for blitzes from a friend. The user selects a blitz by that friend in portrait mode, and then rotates the device the user is using to landscape mode. In landscape mode, the blitz application displays three columns: shared by the recipient to that person, shared by that person, and shared with the recipient from that person. Each column is a scrollable list that the user can swipe up and down on to see items that are filtered to the particular primary key of that column. For example, the user can swipe up and down on the first column to see each of the blitzes shared by the user to that person. The user might select one to change the user's current context or abandon the search and rotate back to continue viewing what the user was viewing. The user can go back and forth between a deep context view in portrait and a selection view in landscape. The application also allows the user to long press to select a changeable secondary key to indicate what type of data is shown in each column. Blitz subject content data types may be files, web pages, QR code scans, and many other types of content, and filtering to just one of these types can help a user find something very specific.

The second example is that of performing a string search to find a blitz. The user starts a keyword search in portrait mode, by entering a string in a search box. The user then rotates the device to landscape mode and gets three types of search results: results with the keyword in title, results with the keyword as a hash tag, and results with the keyword in the comments. Each of these three types of search results is in columns with scrollable lists that the user can swipe up and down to go through a filtered set of search results according to the purpose of each column. The user can also add a secondary key to filter results to only those shared by the user, with the user, publicly, and so forth. The change in orientation, which informs the application of the user's search intent, makes the user's search much more powerful by allowing the user to rapidly narrow down the type of content the user is trying to find.

The third example shows the rich use of context with primary and secondary keys. Rotation has to do with the context the user is coming from. A user can start by looking at shared items in portrait mode, and then rotate to landscape mode to get three columns: shared publicly, privately, or personally. The content item that is currently selected in portrait mode provides the context for what is displayed when the user switches to landscape mode. The user can flip through each column separately. The secondary key becomes type: files, websites, scanned codes, and so forth. If the combined view (both public and private posts) is displayed in portrait mode, then rotation to landscape sets the primary key as type, and the secondary key is how shared. Different selections in portrait view affect what will be displayed in landscape view.

The fourth example shows how orientation can be used with promotions from retailers. Every retailer a user chooses to follow in the blitz application has a location available in the location band. By selecting one location, the user can select a promotion. Alternatively, the user can look at promotions in some other way (such as those shared by friends) and select one. Then, when the user rotates the device to landscape mode, the user can see all of that retailer's promotions in one column and the selected promotion's content in another column. This provides an efficient way to navigate through and find one among potentially millions of promotions to which a user might have access. In addition, retailers can provide a dedicated landscape mode user interface that the system will display when the user rotates into the landscape mode of this promotion provider.

The fifth example shows how orientation can be used with related blitz stacks by views. Image search on a site like Google often provides a list of related images below any image that a user selects. Therefore, a user might select one image, see a list of related images, select one of those and see a new list of related images, and so forth. A similar behavior is provided in the blitz application. The user can swipe up and see related blitzes while looking at any blitz. By rotating, if audience is selected, the user can quickly see how things are shared (by the recipient, with the recipient, publicly). If the user selects a new blitz, when the user rotates back to portrait mode, that blitz will be selected, and the user can do this repeatedly as a method of navigation. Rotation mode becomes a browsing experience.

In the sixth example, a user is able to quickly find Facebook posts of a particular author. The user first comes across a post that is a Facebook post, and selects the post to go to that author's Facebook page. If the user now rotates the device to landscape mode, the user can quickly see things the user has liked on that author's page, posts the user has made on that author's page, and comments the user has made on that author's page. This provides a very useful view into what is potentially a lot of content on a page, filtered based on the user viewing the page. Secondary key can be type: file, website, scan, and so on, to further filter the results. In a sense, the user is seeing only the user's own content, or the author's content that the user has had some previous interaction with, on a particular author's page.

In the seventh example, a user can perform inter-device screen interactions in conjunction with the methods described herein, referred to as content exploration based on context transfer. The context transfer goes into landscape mode where the user can perform content exploration. When the user has performed a search as described above by first selecting an item that provides context in portrait mode, then rotating to landscape mode to search for other content, the user is presented with multiple columns of data in landscape mode. In one search tool provided by the blitz application, a two-dimensional set of rows and column allows the user to slice data by location in one row, person in another, and various tools such as a search tool in another. Thus, a user might select a particular location, person, and the search tool to get a list of posts that relate to that set of filter criteria. By swiping down, the user gets content that meets the current filter criteria on the present device. However, by swiping up the user can send content that meets the current filter criteria to another device, such as a large, wirelessly connected screen for sharing the content with others, or to another nearby user's device.

In the eighth example, a user can dynamically configure search sliders. The blitz application has a concept of where the application is being used. The application can either be used when not on Wi-Fi or not close to a provider, or may be used on a particular provider's network, which provides powerful location and other information. When not connected, a search interface has location, audience, and tools on one side, products, groups, and content on the other. Once in the context of a provider the latter three may become Nordstrom, Designers, and Special Deals, for example. Searches can then happen by swiping up or down in a grid, as described in the previous example. The user can customize the left three data slices by selecting among the right three. By selecting a particular person, the left three become configured how that person uses them. Left sliders are dynamically configured based on providers and friends selected.

Search-ability of the sliders can also be configured by metadata mined from a feed context where an item is found, such as Facebook for a Facebook post. In addition to the columns in landscape mode being something like how posts are shared, they can also come from other context and the content of the configurable sliders on the right, left, or other location of the user interface. For example, rotating to the landscape mode from a portrait detail view of a particular item, could have location context set in a location tab/slider, audience information set in an audience tab/slider, and other context information. Content of the columns could be photos I′m tagged in, places I have been, and any other information related to the original Facebook post being viewed in the portrait mode. Thus, the system provides very powerful multi-dimensional slicing of data to help a user find potentially very specific items among relatively large pools of data.

In the blitz application used in these examples, a user can at any time override a left side slider configuration by swiping down across onto a tool icon, which will scope the current left slider configuration: 1) according to a person's usage of this current slider configuration, 2) if the location is also extended the left sliders are configured with menu content from the location and scoped by the selected user's use pattern, and 3) if the audience slider is not extended (indicating no user selection) and only a location is extended, the full left slider configuration is simply set up according to the menu set provided by the location in the location slider.

In some embodiments, the orientation input system provides a set of just-in-time tools that change based on where a user is located (e.g., on Nordstrom's Wi-Fi network, the tools are reconfigured for Nordstrom's promotions and other information). With a tool configured like a menu system in one right hand slider, location can be selected from a right hand location slider, a person can be selected from a right hand audience slider, and a tool can be selected from the tool slider that can be a menu tool. This will configure the left hand sliders to be the new menu system based on that location and user. This provides a just-in-time toolset or menu system that is produced according to one user's use of a particular location's tools.

Another feature provided by the blitz application is a secure link agent, which allows the control and provisioning of soft links to content generated and shared from within the blitz application. A soft link is a uniform resource locator (URL) that can be opened and viewed in any web browser or equivalent content reader that is capable of rendering the content pointed to by the soft link. Any time a blitz (container of content, where content might be an image, a URL, or a collection of soft links to other blitzes and other web content) is shared, what is shared is a thumbnail image and a secure blitz link (SBL). An SBL is a provisioned link back to the secure link agent (SLA), which is a mediator/generator of new soft links. These new soft links are provisioned and point into a translation table thus allowing the real content to be pointed to and thus pulled from any browser/render object.

This SBL can then be shared onto social media as postings or sent to recipients through email. When this secure link is opened/clicked, the provisioned translation is converted into a number of soft links, which in turn will be translated by the back end to absolute content links. These content links are returned to the content rendering object at the receiver's end. These soft links then may be correctly dereferenced on the back end or broken based on the configuration by the blitz producer (the user of the blitz application). The user thus has control over all blitzes and single content pieces within a blitz allowing for any granularity of control of viewability of content. The user can now send content to any receiver or make any posting that can be viewed just once and if the user wishes the user could provision what viewer (application) can be used to view the blitz. This application control allows the user to specify that the recipient sees the content for only x seconds and then the content is gone. In that viewing process, there is not a single link shared that can be copied by the receiver and used in any subsequent way for subsequent viewing, production, or reproduction of the content. By standing as an intermediary between content shared and the recipient of that sharing, the system allows very precise control of content.

The blitz application is just one of many content domains to which the orientation input system can be applied, and the above examples are meant to show the power of the techniques of the orientation input system without limiting the system to any one application.

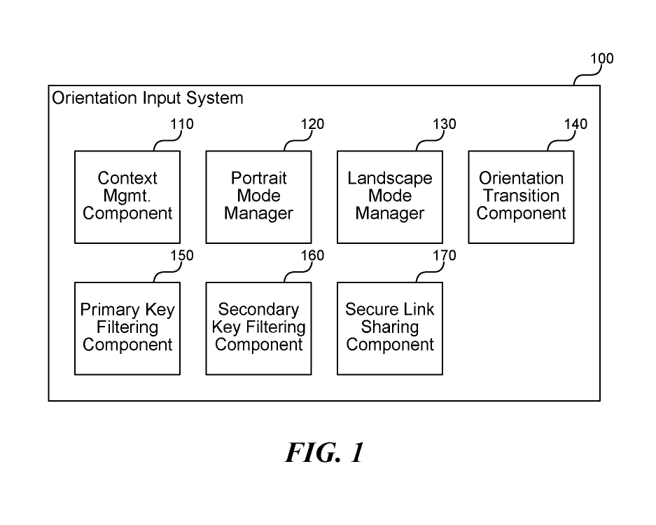

FIG. 1 is a block diagram that illustrates components of the orientation input system, in one embodiment. The system 100 includes a context management component 110, a portrait mode manager 120, a landscape mode manager 130, an orientation transition component 140, a primary key filtering component 150, a secondary key filtering component 160, and a secure link sharing component 170. Each of these components is described in further detail herein.

The context management component 110 manages a current context that indicates the core focus of what the user is currently doing. This may be viewing a particular content item, in which case the content item is the context, performing a search, in which case the search keywords and other search input may be the context, and so forth. Content items may be emails, blog posts, news articles, social media posts (e.g., tweets or Facebook posts), files, QR code scans, or any other type of content that can be electronically shared. The context management component 110 tracks what the user is currently doing and as the user navigates from one item to another tracks the current item that the user is focused on, so that portrait and landscape modes can apply this context to display the right user interface.

The portrait mode manager 120 manages the display of information in the portrait mode of a portable electronic device, where the portrait mode is an orientation of the device so that the device's screen is taller than it is wide. Portrait mode is well suited to displaying in depth information about a single content item or focusing on a single task. Portrait mode is particular good for content that can be scrolled vertically to read, such as a long blog post, an email, or other single content item. Portrait mode is also well suited to single lists, such as a list of the emails in a user's email inbox, a list of new news posts, and so forth. The portrait mode manager 120 works with the context management component 110 to access a current context of the user's activity and to display detail information about that context in the portrait mode.

The landscape mode manager 130 manages the display of information in the landscape mode of the portable electronic device, where the landscape mode is an orientation of the device so that the device's screen is wider than it is tall. Landscape mode is well suited to comparing things side by side or to selecting among various different things displayed in multiple, potentially independent, lists. For example, landscape mode is good for filtering content along multiple different criteria, or data slices. For example, displaying a list of posts from a particular author in one column, to that user in another column, and visible by that user in another column. In this example, each of these datasets is related in that they share a connection to the same author, but they are different and each allows the user to see the data in a different way. The landscape mode manager 130 works with the context management component 110 to access a current context of the user's activity and to display selection information related to that context in the landscape mode. The landscape mode can allow a user to transition from the context of one selected post in portrait mode, via a list of other selectable items, to a new selected post, which can again be viewed in more detail in portrait mode.

The orientation transition component 140 manages the changing display of content upon detecting that the user has changed the orientation of the portable electronic device from portrait mode to landscape mode or from landscape mode to portrait mode, so that different content is displayed in each mode in a manner that allows the user to navigate content by using the orientation as an input user interface control. Orientation changes in the orientation input system 100 do not simply lead to a different layout of the same content as in traditional systems. The content is not simply reformatted to fit the new screen dimensions and orientation. Rather, each mode is used to display different, but related, content that helps the user to navigate a large body of data. For example, while portrait mode may display details about a single item or list of items, such as emails, landscape mode may provide a search interface for finding other similar items, such as emails from the same sender. Thus, while a context is shared between portrait and landscape mode to provide a relevant transition between the two, the context displayed in each mode and the purpose of the user in each mode may be different. The orientation transition component 140 manages this transition, and displays the appropriate interface determined by the application designer for each mode. The orientation transition component 140 may use hardware of the portable electronic device, such as a tilt sensor, gyroscope, or other hardware sensors, to determine when the device orientation has changed. Many portable electronic devices provide a notification to applications from the operating system when orientation has changed.

The primary key filtering component 150 operates in landscape mode to divide content for display according to a first search criteria. The primary key may be who shared a particular content item (e.g., the item's author), what type of content item the current context refers to (e.g., a file, QR code scan, web page, or other type), a location from which the item was shared (e.g., a particular retail store, geographic location, organization, or other location), and so forth. In the landscape mode where the primary key is who shared an item, the system 100 may display two or more columns of data, where one column could be a list of other items shared by that person, another column could be other items shared by that person to the current user, and another column could be other items of that person that the current user has commented on. The primary key divides data up along some criteria for searching and reduces the dataset so that the user can find other content items.

The secondary key filtering component 160 optionally provides a second criterion for filtering content items in the landscape mode. If the primary key is who shared an item, then the secondary key might be the item type. This allows the user to further filter the dataset of possible items to find a particular item the user might be looking for. For example, if the user knows he or she is searching for a file that was shared by a particular user, then selecting type equal to file as a secondary key in combination with who shared as the primary key will quickly lead the user to the particular item the user is looking for, or will at least weed out a number of results known by the user not to be relevant so that the user is more likely to find the item the user is looking for.

The system optionally provides a secure link sharing component 170 through which the system acts as an intermediary between content shared by an author and the user that views that shared content. This allows the sharing author to provision how the content is shared, and to restrict how the content is viewed. For example, the sharing author could elect to restrict how long the shared content is available for viewing, in what application the content can be viewed, who can see the shared content, and so forth. The system does this without exposing the original location of the content so that recipients of the shared content cannot simply go to the original content source and circumvent the sharing author's provisioned restrictions on the shared content.

The computing device on which the orientation input system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, tablet computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

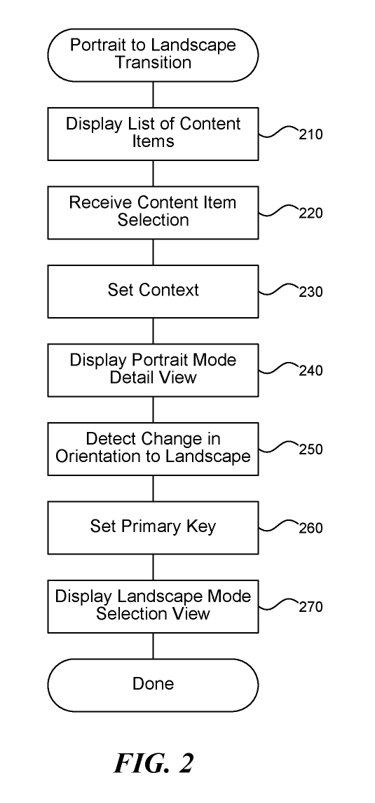

FIG. 2 is a flow diagram that illustrates processing of the orientation input system to navigate content using a transition from portrait to landscape mode, in one embodiment.

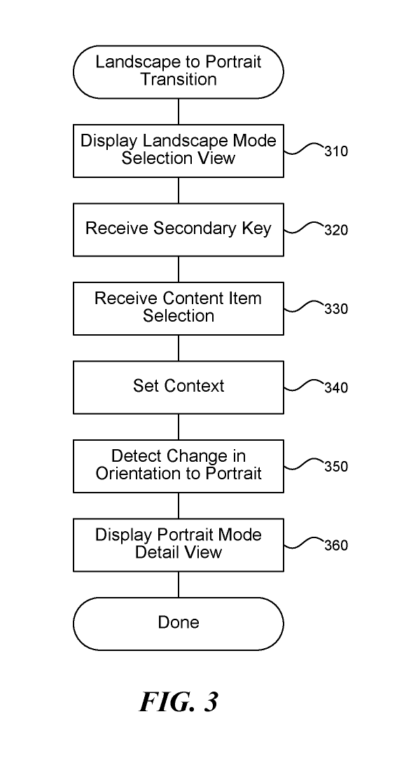

Beginning in block 210, the system displays a list of content items from which the user can select a particular content item. This list may be displayed in portrait mode or the user may be coming from landscape mode to portrait mode, as described further with reference to FIG. 3. The list of content items could be a list of emails, a web page filled with hyperlinks, a Facebook page filled with posts, a folder filled with files, or any other type of list of content commonly displayed on a portable electronic device. The items may be presented by the user interface as clickable or touchable elements that the user can select.

Continuing in block 220, the system receives a selection of a particular content item that the user wants to display detailed information for in the portrait mode. The user may select an item by tapping on it or indicating in some other way through the user interface that the item is the focus of the user's current activity. For example, if the user is viewing a list of email messages, then the user may tap on one of the email messages to view that message's body and other content (e.g., subject, attachments, and so forth). The user may use any available input facility to select an item, such as using speech recognition to select an item by speaking its number or other identifier.

Continuing in block 230, the system sets an internally managed context to the selected content item. The internally managed context is used to determine what to display in the current orientation mode. For example, if the context is a single content item and the portable electronic device is oriented in portrait mode, then the context is used to access details of that item for displaying a detailed portrait view. If, on the other hand, the device is in a landscape orientation, then the context may be used to find other relevant items that are related to the current item in a selection view. Context is a powerful input of its own and the system's knowledge of a current context can save the user from unnecessary input to inform the system what the user is currently doing.

Continuing in block 240, the system displays a detail view of the selected content item in portrait mode. The detail view is well suited to seeing in depth information about a single item or a single list of items that are all related in some way. For example, the detail view may display a single email or Facebook post, or a single list of email messages or Facebook posts. Because the portrait mode is tall and narrow, it is best for scrolling vertically through a list of details about one item or a list of items. For example, reading a long post is well suited for portrait mode, and the user may select an item and orient the device in this way for that purpose.

Continuing in block 250, the system detects a change in orientation of the portable electronic device from portrait to landscape mode. The user's change in orientation of the device is used as an input signal to the system to indicate that the user has a new goal and wants to do something different from viewing the current detail view. Unlike existing systems that simply assume that a change from portrait to landscape mode involves reformatting the same content for the different screen size, the orientation input system uses the change in orientation as a signal to do something different. For example, while the portrait mode is used for detail consumption, the landscape mode can be a signal that the user wants to search and make a new selection for viewing details of a different item. The system receives a notification from the device's operating system that the orientation has changed, and responds by displaying a new user interface using the internally managed context. In some embodiments, the new user interface is a selection view that is related to the currently selected item, but allows the user to find and select other related items.

Continuing in block 260, the system sets a primary key that determines how items are filtered in a landscape selection view based on the internally managed context. The primary key is determined based on the internally managed context. If, for example, an email is selected and provides the current context, then the primary key may be based on the author of the email, the recipient of the email, the subject of the email, or other data related to the selected content item. The primary key provides some filtered view into this data. If, for example, the author of the email is the basis for the primary key, then the filtering may be based on other content items shared by that author, other content items sent from that author to the current recipient, other content items to which the current recipient has responded to the author, and so forth.

Continuing in block 270, the system displays the landscape selection view with content items filtered based on the set primary key. The landscape view provides an interface for selecting a new content item based on an existing content item, and can be an advanced search interface, but with more powerful filtering criteria than are currently available and easy to use on a portable electronic device. The selection view may display one or more columns and rows of information, and the user may arrange what is in each column and row (e.g., by swiping or other input) to align various items to define a new selection. For example, by lining up several criteria in a particular column and swiping down across the column, the user may initiate a search based on the values of those three columns. This provides a very powerful search interface that is easy to use with simple touch input on a portable electronic device. After block 280, these steps conclude.

FIG. 3 is a flow diagram that illustrates processing of the orientation input system to navigate content using a transition from landscape to portrait mode, in one embodiment.

Beginning in block 310, the system displays a landscape selection view with content items filtered based on a set primary key. The landscape view provides an interface for selecting a new content item based on an existing content item, and can be an advanced search interface, but with more powerful filtering criteria than are currently available and easy to use on a portable electronic device. The selection view may display one or more columns and rows of information, and the user may arrange what is in each column and row (e.g., by swiping or other input) to align various items to define a new selection. For example, by lining up several criteria in a particular column and swiping down across the column, the user may initiate a search based on the values of those three columns. This provides a very powerful search interface that is easy to use with simple touch input on a portable electronic device.

Continuing in block 320, the system optionally receives a secondary key to further filter displayed items for selection. If the primary key is a person, such as who shared a content item, then the secondary key may be another criterion, such as the type of the content item (e.g., file, web page, social media post, QR code scan, and so on). The secondary key provides a second layer of filtering of items and for very large datasets can help the user to zero in on a particular item that the user is looking for. Because the primary and secondary keys may be very different, they together can provide a powerful way of filtering content along multiple dimensions.

Continuing in block 330, the system receives a selection of a particular content item that the user wants to display detailed information for in the portrait mode. The user may select an item by tapping on it or indicating in some other way through the user interface that the item is the focus of the user's current activity. For example, if the user is viewing a selection view with multiple lists of email messages in various columns, then the user may tap on one of the email messages to view that message's body and other content (e.g., subject, attachments, and so forth). The user may use any available input facility to select an item, such as using speech recognition to select an item by speaking its number or other identifier.

Continuing in block 340, the system sets an internally managed context to the selected content item. The internally managed context is used to determine what to display in the current orientation mode. For example, if the context is a single content item and the portable electronic device is oriented in portrait mode, then the context is used to access details of that item for displaying a detailed portrait view. If, on the other hand, the device is in a landscape orientation, then the context may be used to find other relevant items that are related to the current item in a selection view. Context is a powerful input of its own and the system's knowledge of a current context can save the user from unnecessary input to inform the system what the user is currently doing.

Continuing in block 350, the system detects a change in orientation of the portable electronic device from landscape to portrait mode. The user's change in orientation of the device is used as an input signal to the system to indicate that the user has a new goal and wants to do something different from viewing the current detail view. Unlike existing systems that simply assume that a change from landscape to portrait mode involves reformatting the same content for the different screen size, the orientation input system uses the change in orientation as a signal to do something different. For example, while the landscape mode is used for selection and searching for items, the portrait mode can be a signal that the user wants to drill into more detail on a particular item. The system receives a notification from the device's operating system that the orientation has changed, and responds by displaying a new user interface using the internally managed context. In some embodiments, the new user interface is a detail view that is related to the currently selected item, and allows the user to consume that item in more depth.

Continuing in block 360, the system displays a detail view of the selected content item in portrait mode. The detail view is well suited to seeing in depth information about a single item or a single list of items that are all related in some way. For example, the detail view may display a single email or Facebook post, or a single list of email messages or Facebook posts. Because the portrait mode is tall and narrow, it is best for scrolling vertically through a list of details about one item or a list of items. For example, reading a long post is well suited for portrait mode, and the user may select an item and orient the device in this way for that purpose. After block 360, these steps conclude.

The user can continue in the manner described in FIGS. 2 and 3 repeatedly as a method of navigation. For example, the user may start by viewing a list of items in portrait mode, select an item, view details about that item, then reorient to landscape mode to find a related item, select that item, then reorient to portrait mode to view details about that item, and so on.

From the foregoing, it will be appreciated that specific embodiments of the orientation input system have been described herein for purposes of illustration, but that various modifications may be made without deviating from the spirit and scope of the invention. Accordingly, the invention is not limited except as by the appended claims.

I/we claim:

1. A computer-implemented method for a user to navigate content on a portable electronic device using a user-initiated transition of the device's orientation from a portrait mode to a landscape mode, the method comprising:
displaying a list of content items from which the user can select a particular content item;
receiving a selection of a particular content item that the user wants to display detailed information for in the portrait mode, which is then referred to as a selected content item;
setting an internally managed context to the selected content item;
displaying a detail view of the selected content item in the portrait mode;
detecting a change in orientation of the portable electronic device from portrait to landscape orientation;
setting a primary key that determines how items are filtered in a landscape selection view based on the internally managed context; and
displaying a landscape selection view with content items filtered based on the set primary key,
wherein the preceding steps are performed by at least one processor.

2. The method of claim 1 wherein displaying the list of content items comprises displaying a list of content items in portrait mode from which the user can select one or more.

3. The method of claim 1 wherein displaying the list of content items comprises displaying a list of content items in landscape mode in a selection view and detecting that the user changed the device's orientation to portrait mode.

4. The method of claim 1 wherein receiving the selection of the particular content item comprises receiving a tap via a touch interface to indicate that the particular content item is a focus of the user's current activity.

5. The method of claim 1 wherein setting the internally managed context comprises determining a content item that will supply details for a detail view of the portrait mode.

6. The method of claim 1 wherein setting the internally managed context comprises determining a content item that will supply other related items for a selection view of the landscape mode.

7. The method of claim 1 wherein setting the internally managed context saves the user from unnecessary input to inform the portable electronic device what the user is currently doing.

8. The method of claim 1 wherein displaying the detail view comprises displaying one or more details from which the user can explore content of the selected content item.

9. The method of claim 1 wherein the portrait mode provides a view of the portable electronic device that is tall and narrow, and wherein displaying the detail view displays details in a manner for scrolling vertically through a list of details related to the selected content item.

10. The method of claim 1 wherein detecting the change from portrait to landscape orientation comprises receiving a notification from the portable electronic device's operating system indicating that the portable electronic device's orientation has changed and interpreting the notification as an input signal to indicate that the user has a new goal and wants to do something different from viewing the current detail view.

11. The method of claim 1 wherein detecting the change from portrait to landscape orientation comprises interpreting the change in orientation as a signal that the user wants to leave the detail view and perform a search for content items related to the selected content item.

12. The method of claim 1 wherein setting a primary key comprises filtering information displayed in the landscape mode based upon at least one detail of the selected content item from the portrait mode.

13. The method of claim 1 wherein displaying the landscape selection view comprises providing a user interface for selecting a new content item based on the selected content item.

14. The method of claim 1 wherein the landscape selection view displays one or more columns and rows of information, and the user may arrange what is in each column and row to align various items to define a new selection by swiping across multiple rows in a column.

15. A computer system for navigating content by changing screen orientation, the system comprising:
a processor and memory configured to execute software instructions embodied within the following components;
a context management component that manages a current context that indicates a core focus of what the user is currently doing;
a portrait mode manager that manages display of information in a portrait mode of a portable electronic device, where the portrait mode is an orientation of the device so that the device's screen is taller than it is wide;
a landscape mode manager that manages display of information in a landscape mode of the portable electronic device, where the landscape mode is an orientation of the device so that the device's screen is wider than it is tall;
an orientation transition component that manages a changing display of content upon detecting that the user has changed the orientation of the portable electronic device from the portrait mode to the landscape mode or from the landscape mode to the portrait mode, so that different content is displayed in each mode in a manner that allows the user to navigate content by using orientation as an input user interface control; and
a primary key filtering component 150 that operates in landscape mode to divide content for display according to a first search criteria.

16. The system of claim 15 wherein the portrait mode manager communicates with the context management component to access the current context of the user's activity and to display detail information about that context in the portrait mode.

17. The system of claim 15 wherein the landscape mode manager communicates with the context management component to access the current context of the user's activity and to display related items in a selection view in the landscape mode.

18. The system of claim 15 further comprising a secondary key filtering component that provides a second criteria for filtering content items in the landscape mode.

19. The system of claim 15 further comprising a secure link sharing component through which the system acts as an intermediary between content shared by a sharing author and the user that views that shared content to allow the sharing author to provision how the content is shared, and to restrict how the content is viewed.

20. A computer-readable storage medium comprising instructions for controlling a computer system to navigate content on a portable electronic device using a user-initiated transition of the device's orientation from a landscape mode to a portrait mode, wherein the instructions, upon execution, cause a processor to perform actions comprising:
displaying a landscape selection view with content items filtered based on a set primary key, wherein the landscape selection view provides an interface for selecting a new content item based on an existing content item;
receiving a selection of a particular content item in the landscape selection view that the user wants to display detailed information for in the portrait mode;
setting an internally managed context to the selected content item;
detecting a change in orientation of the portable electronic device from landscape to portrait mode; and
displaying a detail view of the selected content item in portrait mode, wherein the detail view displays in depth information about a single item or a single list of items that are all related.
